(19) United States
(12) Patent Application Publication
(10) Pub. No.: US 2026/0050478 A1
(43) Pub. Date: Feb. 19, 2026

(54) Reciprocating Locks

(71) Applicant: Oracle International Corporation, Redwood City, CA (US)

(72) Inventors: David Dice, Foxboro, MA (US); Alex Kogan, Needham, MA (US)

(21) Appl. No.: 19/197,839

(22) Filed: May 2, 2025

Related U.S. Application Data
(60) Provisional application No. 63/683,154, filed on Aug. 14, 2024.

(51) Int. Cl. G06F 9/50

(52) U.S. Cl. CPC G06F 9/5027

(57) ABSTRACT

One or more processors and memory may implement threads that perform allocations of a lock operation to synchronize access to a resource. Associated with the lock are two queues, an arrival queue and a wait queue. To allocate a lock, a thread pushes an allocation request onto the head of the arrival queue. When another thread holding the lock completes access to the resource, that thread transfers control according to a most recently arrived request in the wait queue. If no requests exist in the wait queue, the other thread transfers all requests, in arrival order, from the arrival queue to the wait queue, then transfers control according to a most recently arrived request in the wait queue. Requests segments transferred from the arrival queue to the wait queue are processed in first-in-first-out order while individual requests in a segment are processed in last-in-first-out order.

### RELATED APPLICATIONS

This application claims benefit of priority to U.S. Provisional Application Ser. No. 63/683,154, entitled “Reciprocating Locks,” filed Aug. 14, 2024, and which is incorporated herein by reference in its entirety.

### BACKGROUND

### Field Of the Disclosure

This disclosure relates generally to concurrent programming, and more particularly to systems and methods for performing concurrent synchronization using software lock operations.

### Description of the Related Art

Modern computer systems conventionally include the ability to perform multiple threads of execution simultaneously, thus giving rise to the need to synchronize threads for access to shared data structures. Among these synchronization mechanisms is the lock operation. When using locks, data structures shared among multiple threads have an associated lock and, to access the shared data structure, a thread must first obtain the lock then release the lock once access is complete. Threads which attempt to obtain the lock while it is currently allocated to another thread must wait for the lock to become available.

### SUMMARY

Methods, techniques and systems for providing efficient locks targeting cache-coherent shared memory are described herein. One or more processors and memory may implement threads that perform allocations of a lock operation to synchronize access to a resource. Associated with the lock are two queues, an arrival queue and a wait queue. To allocate a lock, a thread pushes an allocation request onto the head of the arrival queue. When another thread holding the lock completes access to the resource, that thread transfers control according to a most recently arrived request in the wait queue. If no requests exist in the wait queue, the other thread transfers all requests, in arrival order, from the arrival queue to the wait queue, then transfers control according to a most recently arrived request in the wait queue. Requests segments transferred from the arrival queue to the wait queue are processed in first-in-first-out order while individual requests in a segment are processed in last-in-first-out order. The arrival phase and the release phase both run in constant-time, waiting threads use local spinning and only a single waiting element is required per thread, regardless of the number of locks a thread might hold at a given time. The lock technique bounds bypass and has strong anti-starvation properties and is compact, space efficient, provides high throughput under contention and low latency in the uncontended case.

### BRIEF DESCRIPTION OF THE DRAWINGS

FIG. 1 is a block diagram illustrating a system implementing an application execution environment including multiple threads sharing a resource through the use of reciprocating locks.

FIG. 2 is a flowchart illustrating one embodiment of a method for implementing allocation of a reciprocating lock.

FIG. 3 is a flowchart illustrating one embodiment of a method for implementing release of a reciprocating lock.

FIG. 4 is a flowchart illustrating one embodiment of an alternative method for implementing allocation of a reciprocating lock.

FIG. 5 is a table illustrating palindromic admission schedules of a reciprocating lock, in at least one embodiment.

FIG. 6 is a block diagram illustrating a number line representing tickets of a ticket lock implementing reciprocating allocation, according to at least one embodiment.

FIG. 7 is a block diagram illustrating a data structure for a lock implemented using a retrograde ticket lock, according to at least one embodiment.

FIG. 8 is a flowchart illustrating one embodiment of a method for implementing allocation of a retrograde ticket lock.

FIG. 9 is a flowchart illustrating one embodiment of a method for implementing release of a retrograde ticket lock.

FIG. 10 is a block diagram illustrating one embodiment of a computing system that is configured to implement enhanced ticket lock operations, as described herein.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes”mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S. C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments thinclude any combination of the features are generally contemplated, unless expressly disclaimed herein. Particular features, structures, or characteristics may be combined in any suitable manner consistent with this disclosure.

### DETAILED DESCRIPTION OF EMBODIMENTS

A ticket lock operation is a synchronization primitive for multi-threaded applications that employs a software lock in combination with an allocation strategy that ensures fairness. The ticket lock includes a lock structure consisting of ticket and grant fields. Using a ticket lock, threads desiring to obtain the lock first allocate a ticket by atomically copying a ticket value from the lock structure and incrementing the ticket value in the lock structure. After the ticket is allocated, the thread waits until the grant field of the lock structure equals the allocated ticket value, indicating that the lock is allocated to the thread. Once the thread no longer needs the lock, it releases the lock by incrementing the grant field, which may indicate to another waiting thread that it has been allocated the lock.

Various embodiments of the present invention extend the above ticket lock operation to use one or more wait variables for use by threads that have determined that they require long term wait operations. These one or more wait variables may be private to a particular lock or shared among multiple locks and may be statically sized dependent on anticipated workloads or may be sized in proportion to the number of processors in the host system.

Once a ticket has been allocated and the thread has determined that the lock is not yet available, the thread makes an additional determination whether a long term wait is required by determining if the number of threads already waiting on the lock exceeds a predetermined threshold. If the threshold is not exceeded, the thread proceeds in the same manner as in a conventional ticket lock, but if the threshold is exceeded the thread implements a long term wait using a separate wait variable rather than waiting on the grant field. In doing so, contention for the grant field is reduced or eliminated without increasing latency for low-contention conditions.

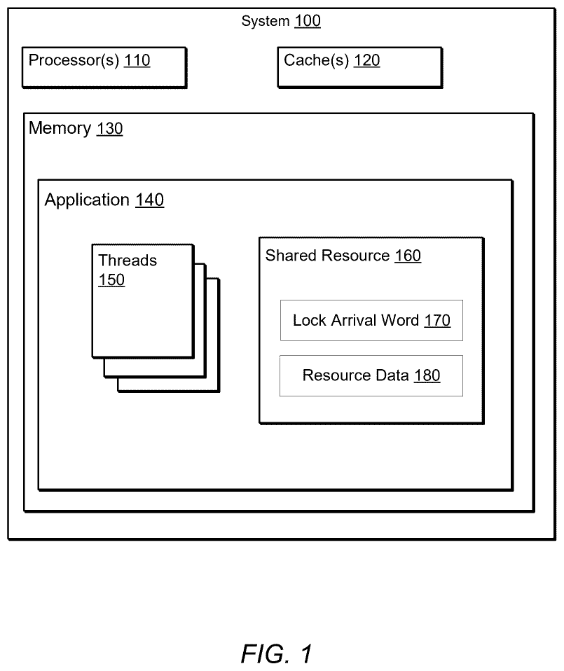

FIG. 1 is a block diagram illustrating a system implementing an application execution environment including multiple threads sharing a resource through the use of ticket locks. The System 100 includes one or more Processors 110 capable executing multiple parallel threads of execution coupled through one or more Caches 120 to a Memory 130 thincludes an Application 140. The Application 140 may include multiple executing Threads 150 that access a Shared Resource 160. The Shared Resource 160 includes a controlling Lock Arrival Word 170 and Resource Data 180 sharable by the Threads 150. To access Resource Data 180 of the Shared Resource 160, one of the Threads 150 must first allocate the Shared Resource 160 using the Lock Arrival Word 170. Once the Shared Resource 160 is allocated, the Thread 150 may access the Resource Data 180 and when the Thread no longer requires access to the Shared Resource 160, the Thread 150 may release the Shared Resource 160 using the Lock Arrival Word 170. While FIG. 1 shows a single application with three executing threads and one shared resource, this example is not intended to be limiting and any number of applications with any number of threads sharing any number of resources may be envisioned.

Reciprocating Locks may partition a set of waiting threads into two disjoints lists called arrival and entry segments. Threads arriving to acquire the lock will push (prepend) themselves onto a stack, using an atomic exchange operation, forming the arrival queue or segment. When a controlling thread releases the lock, it may first try to pass ownership to any threads found in the entry queue or segment. Otherwise, if the entry segment is found empty, the controlling thread may then use an atomic exchange to detach the entire current arrival segment, thus setting it empty, which then becomes the next entry segment, and then passes ownership to the first element of the entry segment.

A lock instance may consist of an arrival word, such as the lock arrival word 170 of FIG. 1. A lock held if the arrival word is non-zero. Specifically, a value of 0, also known as a nullptr value, encodes the unlocked state and a value of one encodes the state of simple locked, locked with an empty arrival segment, with other values encoding a locked state where the remainder of the arrival word points to a stack of threads that have recently arrived at the lock and are waiting for admission, forming the arrival segment.

Threads arriving to acquire the lock use an atomic swap, or atomic exchange, operator to install the address of a thread-private waiting element into the arrival word. If a return value from the atomic exchange was nullptr then the arriving thread managed to acquire the lock without contention and can immediately access the protected resource. Otherwise, the thread has encountered contention and must wait. By virtue of the atomic exchange, the thread has managed to push its waiting element onto the arrival segment, potentially creating a new arrival segment in the process. The non-zero value returned from the atomic exchange identifies the next thread in the stack. A thread knows only the identity of its immediate neighbor in the arrival segment and no explicit linked list of waiting threads is formed or required. That is, the arrival stack is implicit with no next pointer fields in the waiting elements. The thread then proceeds to local spinning on a flag field within its waiting element. This flag will eventually be set during normal ownership succession by another thread running in a release operation, passing ownership to the waiting thread. The waiting thread, upon having its flag set, then becomes the lock holder, then returns the address of the next thread in the entry segment which was obtained from the atomic exchange. That address, returned from the Acquire operation, is passed to the subsequent corresponding invocation of Release. The thread identified by that address will subsequently serve as the successor to the current thread.

In the corresponding Release operator, if a successor was passed from the corresponding Acquire operator, that thread is enabled to enter the critical section by setting the flag in its waiting element. If, however, a successor was not passed, an atomic compare and exchange (CAS) operation is used to swing the arrival word from simple locked state, encoded as one, back to unlocked, encoded as nullptr. If the CAS was successful then no waiting threads exist and the lock reverts to unlocked state. If the CAS failed, however, additional newly arrived threads must be present on the arrival segment. In that case an atomic exchange is used to detach the entire arrival segment, leaving the arrival word in simple locked state, encoded as one. Lock ownership is then passed to the first thread in the detached segment by setting the flag in its waiting element.

Under contention, threads arrive and join the arrival segment. While the entry segment remains populated, ownership may be passed through the entry segment elements in turn. When the current entry segment becomes empty, the Release operator detaches the arrival segment, via an atomic exchange, which then becomes the next entry segment. Threads migrate, in groups, from the arrival segment to the entry segment. The arrival segment consists of those newly arrived threads currently pushed onto the stack anchored at the arrival word while entry segment reflects a set of threads that have already been detached from the arrival stack.

The Release operator consults the entry segment first, via the successor reference passed from Acquire to Release, and passes ownership to the successor if possible. The sequence of successor references passed from Acquire to Release constitutes the entry segment. If the entry segment is empty—the passed successor argument is nullptr—Release then attempts to replenish the entry segment by detaching the arrival segment and transferring ownership to the first element. In the event the arrival segment is found empty, the lock reverts to unlocked state.

The arrival segment is implemented by means of a concurrent pop-stack, where the key primitives are push and detach-all, which makes our technique immune to the A-B-A pathology. By convention, in Reciprocating Locks, only the current lock holder is allowed to detach the arrival segment.

The waiting element may, in some embodiments, be allocated in thread-local storage (TLS). As a thread can wait on at most one lock at any given time, such a singleton suffices, and tightly bounds memory usage.

Given that a stack is used for arriving threads, admission order is last-in-first-out (LIFO) within a segment, but remains first-in-first-out (FIFO) between segments. As such, if thread T1 pushes itself onto the arrival segment in Acquire, and then waits, and T2 arrives and pushes itself after T1, then a given thread T2 can bypass or overtake T1 at most once before T1 is next granted ownership, providing thread-specific bounded bypass and thus avoiding indefinite starvation. Alternatively, Reciprocating Locks can be said to provide classic K-bounded bypass (worst case) where K reflects the cardinality of the population of threads that might compete for the lock, yielding population bounded bypass.

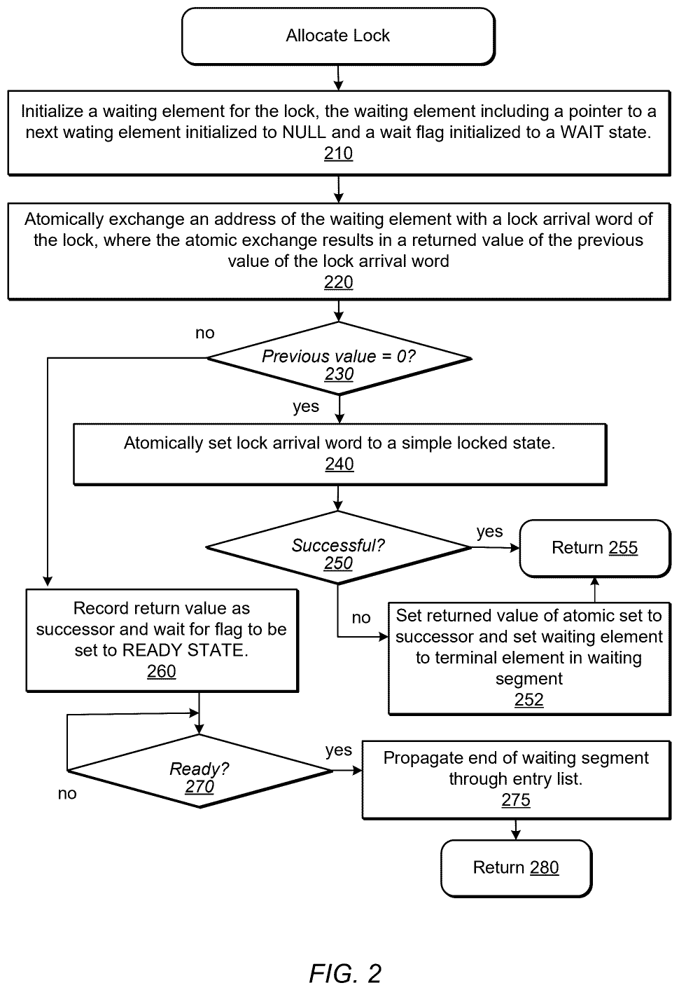

FIG. 2 is a flowchart illustrating one embodiment of a method for implementing allocation of a reciprocating lock. The process begins at 210 where a thread desiring to allocate a lock may initialize a waiting element for the lock by setting a next waiting element field to a NULL value and setting a wait flag to a WAIT state.

Then, in some embodiments the thread may atomically exchange and address of the initialized waiting element with a lock arrival word of the lock. The atomic exchange operation may return a previous value of the lock arrival word which may contain a zero value indicating that the lock is unallocated or a non-zero value indicating that the lock is currently held. In the event of a non-zero value, a value of one indicates that an incoming segment for the lock was previously empty.

If the previous value is zero, as indicated by a positive exit from 230, the process may then proceed to step 240. If the previous value is non-zero, as indicated by a negative exit from 230, the process may proceed to step 260.

At step 240, in various embodiments the lock is currently in an unlocked state. The thread may then atomically set the lock arrival word to a SIMPLE LOCKED state. If the atomic set operation is successful, as indicated by a positive exit from 250, the process is complete, as shown in 255. If the atomic set operation is unsuccessful, as indicated by a negative exit from 250, the process may proceed to step 452.

At step 252, a failure in setting the state of the lock to a SIMPLE LOCKED state indicates that additional threads have been added to the incoming segment. In some embodiments, a return value of the atomic set operation identifies a successor waiting element and the waiting element of the thread is identified as a terminal element as the thread owns the lock but is not positioned in the waiting segment. The process is then complete as indicated in step 255.

At step 260, a non-zero previous value of the lock arrival word indicates that waiting elements already exist for the lock. The previous value of the lock arrival word identifies a successor to obtain the lock from the thread. The successor may be recorded and the thread may enter a waiting state that is terminated when a flag for the waiting element is set to a READY STATE. When the flag is set to a READY STATE, as indicated by a positive exit at 270, the process may proceed to step 275, where an ending element that terminates the waiting segment may be propagated through the entry list before the process returns, as indicated at 280.

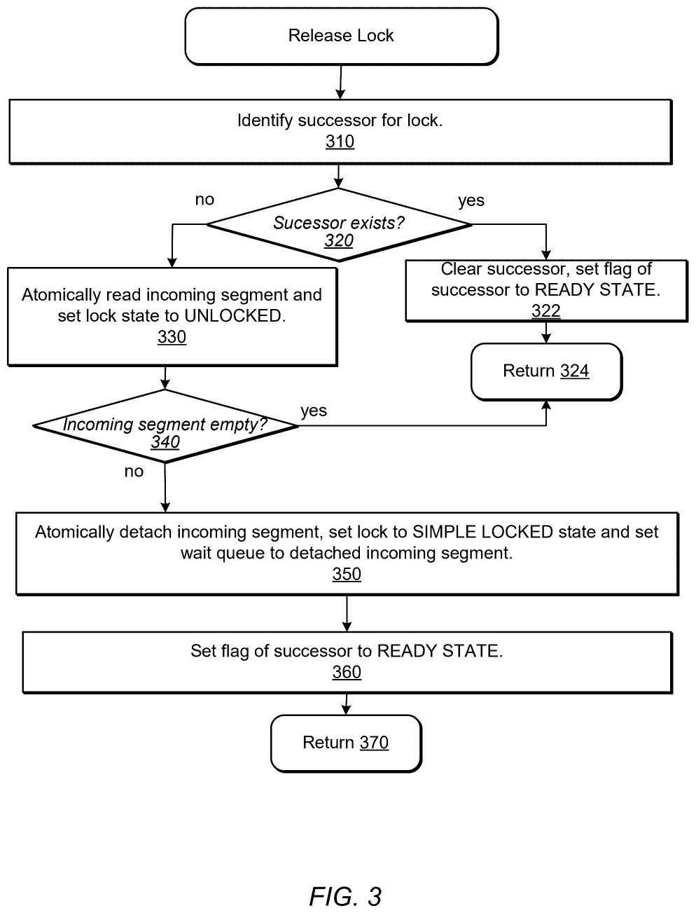

FIG. 3 is a flowchart illustrating one embodiment of a method for implementing release of a reciprocating lock. The process begins at 310, where a successor waiting thread is identified, if one exists, from the waiting segment to transfer control of the lock. If a successor exists, as indicated by a positive exit from 320, the process may advance to 322. If a successor does not exist, as indicated by a negative exit from 320, the process may advance to 330.

As shown in 322, a successor is identified from the waiting segment. Information regarding this successor may be cleared and the flag of the waiting element of the successor set to a READY STATE. The process is then complete, as shown in 324.

As shown in 330, no successor is identified from the waiting segment. The thread may then attempt to transfer the incoming segment to become a new waiting segment. In some embodiments, the thread may atomically read the incoming segment and set the lock state to UNLOCKED, in anticipation that no incoming segment exists. If an incoming segment does not exist, as indicated by a positive exit from 340, the process is complete as shown in 324. If an incoming segment does exist, as indicated by a negative exit from 340, the process may advance to 350.

As shown in 350, the incoming segment may be atomically detached and the lock set to a SIMPLE LOCKED state, with the wait queue updated to contain the detached segment as the new ready segment. Then as shown in 360, the flag of the waiting element of a successor, identified as the head of the new ready segment, may be set to a READY STATE and the process is complete, as shown in 370.

### Simple Uncontended Acquire and Release

:A thread T1 may desire to acquire lock L. L's arrival word is currently nullptr, indicating that L is in unlocked state. At T1 initializes its thread-specific waiting element, E. T1 then swaps the address of E into L1's arrival word. The atomic exchange returns nullptr, indicating no contention for the lock L. T1, recognizing there was no contention, tries to replace the address of E in the arrival word with the simple locked encoding. As no other threads have arrived, the exchange replaces E with value of 1, indicating a simple lock. Control returns and the thread can enter and execute the critical section. The Acquire method of FIG. 2 returns with the successor of the lock L remaining set to nullptr indicating that the entry list is empty and no successor exists. T1 invokes the Release method of FIG. 3, with the lock L successor still set to nullptr. T1 uses an atomic CAS to try to restore L's lock arrival word from a simple state (1) to an unlocked state (0). As no new threads have arrived, the CAS is successful, and T1 returns from Release.

An uncontended Acquire such as shown in FIG. 2 may use two atomic exchange operations, increasing the theoretical remote memory reference (RMR) complexity. In practice, as the lock is uncontended the underlying cache line may tend to remain in local modified state in T1's cache, assuming normal cache coherent shared memory, so the second exchange incurs very little additional cost. In some embodiments, a more complex encodings may avoid this double swap arrival. This double swap manifests only absent contention, where the arriving thread found the lock in unlocked state. Under sustained contention, the double swap is avoided.

### Simple Uncontended Acquire and Release

A race in the Acquire method of FIG. 2 may exist where a thread pushes its wait element onto the stack but, because of other arriving threads, is not able to exchange the arrival word back to a SIMPLE LOCKED state, and its element becomes “submerged” on the arrival stack. This situation is handled by conveying the address of that “submerged” element through the segment, during succession, allowing us to treat the buried element as the effective end-of-segment (equivalent to nullptr) and otherwise ignore it. That address is conveyed through a wait element Terminus field, which is normally nullptr but will be non-nullptr in the case where the race manifested and an element became submerged. This case may be considered as a zombie terminal element. During succession a thread checks the address of the successor to determine if matches the submerged terminal element.

Lock L is in an unlocked state and thread T1 invokes the Acquire method of FIG. 2. T1 executes the atomic exchange to install the address of its wait element E, designated E1, into L's arrival word, the exchange returns 0, so T1 now holds the lock.

Thread T2 now arrives in Acquire and exchanges the address of its wait element, E2 into the lock's arrival word. Thread T3 also arrives in Acquire and pushes the address of its wait element, E3, onto the arrival stack. T1 attempts to replace the address of its E1 with SIMPLE LOCKED state. The exchange, however, returns E3 instead of E1, as T2 and T3 raced T1 in the exchange-exchange window.

T1 is unable to return. At this point, T1's wait element E1 is “buried” or “submerged” in the arrival stack, residing at the distal end, and is not easily removed from the stack. The arrival word is set to a SIMPLE LOCKED state. E3's successor is E2, E2's successor is E1, and E1 has no successor, forming an entry segment that consists of E3→E2→E1. Note that T1 is the owner, but its own E1 also resides on the entry segment stack. To recover, T1 installs the address of its own E1 into its successor E3's Terminus field, which is otherwise set to nullptr. T1 records the address E3 (in variable R) to ultimately be used as T1's successor when T1 subsequently calls Release. T1 enters and executes the critical section. T2 and T3, resuming, observe that the lock was held and must thus wait.

T1 invokes Release on L. The address E3 is passed through a successor field of the lock L. T1 sets the flag in E3, passing ownership to T3. T1 returns from Release. T3 is now the owner, departs its waiting loop, and fetches its Terminus field from E3, observing the address E1. T3's local successor variable (succ) refers to E2, so the equality check is not true. T3 passes the address E1, which represents the logical end-of-segment, into E2's Terminus field. T3 stores E2, which is passed to the corresponding Release. T3, returns and executes the critical section. T3 invokes Release, and observes E2 in L→Succ. T3 sets E2's flag field, passing ownership to T2. T3 returns from Release. T2 observes that its flag field was set, indicating that is now the owner of L. T2's local successor variable refers to E1. T2 fetches from its own E2 Terminus field, observing E1. T2 recognizes, via the address-based check, that it has reached the end of the arrival segment, marked by E1, and returns. T2 returns from Acquire and enters the critical section. T2 invokes Release, and observes that L→Succ is equal to nullptr, indicating the entry segment is empty. T2 attempts to CAS the arrival word from SIMPLE LOCKED (1) to UNLOCKED (0). The CAS succeeds and L is restored to unlocked state and T2 returns. If new threads had arrived and pushed onto the arrival segment, the CAS would fail, and the Release operator would detach the arrival stack, shifting those arrivals to become the next entry segment, and then pass ownership to the most recently arrived element of the entry segment.

Arrival race, the two swaps, are likely to be rare, likely as the window of vulnerability is short, and because it takes time for the coherent interconnect to re-arbitrate the cache line between processors. Also, the race can only occur at the onset of contention, when the first arriving thread found the lock not held and then other threads arrived in quick succession. In the event of the race, the address of E is passed through the Terminus field. E's address is used for addressed-based comparisons as a distinguished marker or sentinel to indicate the logical end-of-segment. E itself, however, will not be subsequently accessed by succession within the segment. Elements associated with a given thread may appear on at most one segment at any time, but, when an address is used as an end-of-segment marker, it is possible that it appears on both the arrival segment and entry segment.

The Terminus field may also reside in the lock body instead of in the waiting elements. While viable, that approach increases the size of the lock body, and increases induced coherence traffic. Instead, such shared central fields are avoided by propagating information—in this case the address of the terminal element of the segment—through the chain of waiting elements.

### Sustained Contention

Lock L is initially in unlocked state. Thread T1 arrives in Acquire. T1's exchange operation installs the address of T1's wait element, E1, into L's arrival word. As the exchange returned nullptr, T1 has acquired the lock. T1 then, via the exchange, replaces E1 with a SIMPLE LOCKED (1) state and returns. T1 enters and executes the critical section. While T1 holds L, thread T2 arrives E2 pushes onto the arrival stack. The exchange operation returns a SIMPLE LOCKED (1) state into T2's local tail variable. As tail is non-zero, T2 must wait coerces the LOCKED (1) state to nullptr, as there are no successors in the arrival segment. A SIMPLE LOCKED (1) state is effectively equivalent to nullptr for the purposes of forming the arrival segment. T2 waits on E2. With T1 still holding L, T3 also arrives and uses the atomic exchange to push its element E3 onto the arrival stack. The exchange returns E2 and leaves E2 unchanged. T3's successor variable points to E2. The arrival stack consists of E3 followed by E2. The arrival word points to E3 and T3's successor variable points to E2, while E2's successor variable is nullptr, indicating that E2 is the final element on the arrival segment. The entry segment is empty. T3 waits on E3. Similarly, T4 arrives and pushes E4 onto the arrival stack and then waits. T1 eventually calls Release. As L→Succ is nullptr, indicating an empty entry segment, T1 then attempts the CAS which fails. T1 then executes exchange(1) to detach the arrival segment. The exchange operator returns E4. The arrival segment is now empty and the entry segment consists of E4 then E3 then E2. T1 passes ownership to T4. T4 departs its waiting phase. The Terminus value is nullptr and does not equal successor, which is E3, so control passes to perform a redundant store of an UNLOCKED state (0). T4 sets E3 as its successor, returns, and then enters the critical section. The arrival segment is currently empty and the entry segment consists of just E3 and E2. 9 while T3 holds L, T5 and then T6 arrive to acquire L, pushing E5 and then E6, respectively, onto the arrival stack. The arrival segment consists of E6 then E5 and the detached entry segment is just E3 and E2. T4 calls Release. As E3 is the successor, ownership is granted to T3. T3 departs its wait phase and marks E2 as its successor. T3 enters and executes the critical section. T3 calls Release, observing E2 as its successor and grants ownership to T2. T2 departs its wait phase. The end of the entry segment is reached. As L→Succ is already known to be nullptr, control is returned. T2 enters and executes the critical section.

T2 invokes Release observing L→Succ==nullptr. As the entry segment is now empty and there is no immediate successor, the the CAS is attempted which fails, as the arrival segment is populated. T2 then detaches the arrival segment of E6 then E5, leaving the arrival word set to a SIMPLE LOCKED (1) state and passes ownership to T6. T6 exits its waiting loop, marks E5 as its successor and returns. T6 enters and executes the critical section. T6 invokes Release observing L→Succ==E5. L→Succ is cleared and ownership is granted to T5. T5 exits its waiting loop and returns with L→Succ still set to nullptr, indicating there is no successor in the entry segment. T5 enters and executes the critical section. T5 calls Release observing L→Succ==nullptr. Both the entry segment and arrival segment are empty. The CAS succeeds, and L is restored to unlocked state.

A wait-free atomic exchange operator is assumed. Specifically, the implementation thereof should not be via loops that employ optimistic compare-and-swap or load-locked (LL) and store-conditional (SC) primitives. In particular the atomic_exchange and compare_and_exchange primitives may be implemented in a wait-free fashion, as is the case on AMD or Intel x86 processors or ARM processors that support the LSE instruction subset.

As described above, various embodiments place wait elements in thread-local storage. This simplifies memory correctness as the tenure and lifespan of thread-local storage is the same as that as the associated thread. Wait elements can also be safely allocated on-stack, in the activation frame of Acquire. This reduces memory usage to K *W+L*B where K is the number of waiting threads, W is the size of the waiting element in the stack frame, L is the number of currently extant locks, and B is the size of the lock body.

At a conceptual level, the element on which threads spin requires a short lifespan (tenure) and is only required to exist and remain in scope for the duration of the Acquire operation, and as such can be allocated in the Acquire function's frame.

In some circumstances—zombies—the address of an element is used as an end-of-segment marker. In this case the address escapes the frame as it passed through the Terminus field. Specifically, the address of the wait element has a longer lifespan than the wait element itself, and the address persists even after the wait element has fallen out of scope. Address-based comparisons may be used to detect the end-of-segment, but the defunct wait elements are not referenced.

In some embodiments, a standard pthread-style locking interface, with simple Acquire and Release operators that pass no additional information other than a reference to the lock, may be provided. Non-standard interfaces, however, may confer various advantages. For instance, if the Succ field were removed from the lock body and instead return a reference to the successor from Acquire and then subsequently passed into the corresponding Release, the size of the lock body and remote memory references may be reduced. Specifically, the identity of the owner's successor on the entry segment—embodied as the address of the successor thread's waiting element—is returned and passed from the Acquire operation to the corresponding Release operator.

Instead, to avoid imposing a non-standard interface, and provide a standard context-free programming interface, the address of the successor is passsed through an extra field in the lock body, which can induce extra coherence traffic. Another approach is to keep track of held locks in thread-local storage (TLS) and convey the information in that fashion. Most locking algorithms that are not innately context free can be transformed to become context free through such techniques.

Modern locking constructs such as std::scoped_lock and std::lock_guard, by means of the Resource Acquisition is Initialization (RAII) idiom, where the constructor acquires the lock and the destructor releases the lock, manage to avoid explicit lock and unlock calls in application code. This same design pattern readily supports underlying lock primitives that require context to be passed. Specifically, extra context may be passed through additional fields in the RAII wrapper classes. Likewise, locking interfaces that specify the critical section as a lambda also allow such latitude. Interfaces that use scoped locking, such as Java's “synchronized” construct, permit the implementation to trivially pass information from the underlying lock cite to the corresponding unlock.

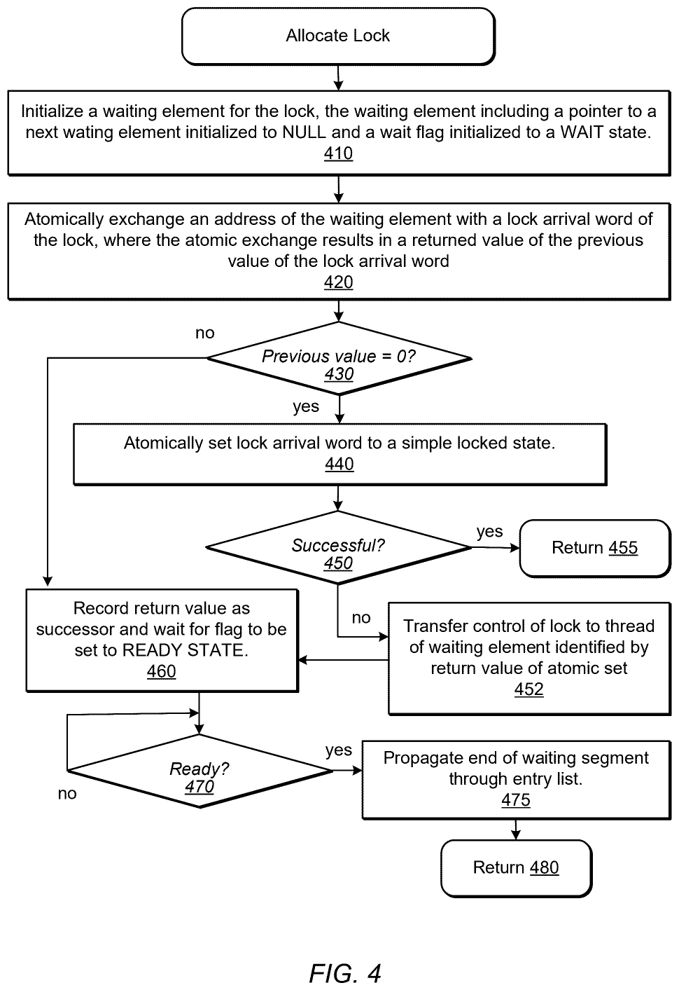

FIG. 4 is a flowchart illustrating one embodiment of an alternative method for implementing allocation of a reciprocating lock. The process begins at 410 where a thread desiring to allocate a lock may initialize a waiting element for the lock by setting a next waiting element field to a NULL value and setting a wait flag to a WAIT state.

Then, in some embodiments the thread may atomically exchange and address of the initialized waiting element with a lock arrival word of the lock. The atomic exchange operation may return a previous value of the lock arrival word which may contain a zero value indicating that the lock is unallocated or a non-zero value indicating that the lock is currently held. In the event of a non-zero value, a value of one indicates that an incoming segment for the lock was previously empty.

If the previous value is zero, as indicated by a positive exit from 430, the process may then proceed to step 440. If the previous value is non-zero, as indicated by a negative exit from 430, the process may proceed to step 460.

At step 440, in various embodiments the lock is currently in an unlocked state. The thread may then atomically set the lock arrival word to a SIMPLE LOCKED state. If the atomic set operation is successful, as indicated by a positive exit from 450, the process is complete, as shown in 455. If the atomic set operation is unsuccessful, as indicated by a negative exit from 450, the process may proceed to step 452.

At step 452, a failure in setting the state of the lock to a SIMPLE LOCKED state indicates that additional threads have been added to the incoming segment. In some embodiments, ownership of the lock is transferred to a thread identified by a return value of the atomic set operation by setting a flag associated with the thread to a READY STATE. The process is then advances to step 460.

At step 460, a non-zero previous value of the lock arrival word indicates that waiting elements already exist for the lock. The previous value of the lock arrival word identifies a successor to obtain the lock from the thread. The successor may be recorded and the thread may enter a waiting state that is terminated when a flag for the waiting element is set to a READY STATE. When the flag is set to a READY STATE, as indicated by a positive exit at 470, the process may proceed to step 475, where an ending element that terminates the waiting segment may be propagated through the entry list before the process returns, as indicated at 480.

### Palindromic Admission Schedules

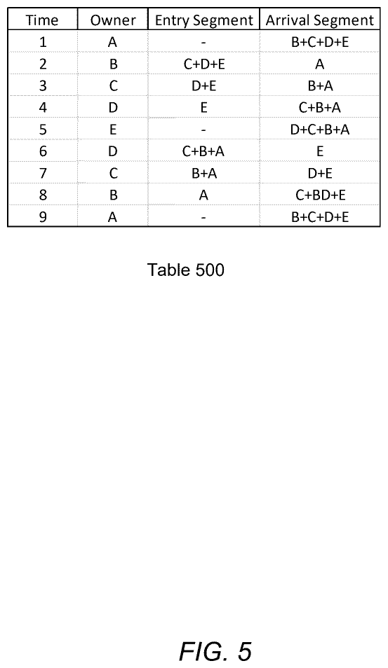

Reciprocating Locks may allow a palindromic admission schedule which, under the right circumstances, can persist for long periods. FIG. 5 is a table illustrating palindromic admission schedules of a reciprocating lock, in at least one embodiment. Table 500 illustrates the phenomena with a simple scenario. Threads A B C D and E all complete for a given lock L. Initially, at time 1, A is the owner, executing in the critical section, the entry segment is empty and the arrival segment consists of B then C then D then E (B+C+D+E). The non-critical section is empty, so when a thread releases the lock, it immediately recirculates and tries to reacquire. A completes the critical section and invokes Release, which, as the entry segment is empty, reverts to and detaches the arrival segment of B+C+D+E and moves those threads en-masse to entry segment, and then passes ownership to the head of the entry segment, B. A recirculates, calls Acquire again, and emplaces itself on the arrival segment, reflecting the state at time 2. Next, B releases the lock, and passes ownership to C. B then calls Acquire and prepends itself to the arrival segment stack, which now contains B+A, as shown at time 3. C releases the lock and conveys ownership to the head of the entry segment, D. C then recirculates and pushes itself onto the arrival segment, which now holds C+B+A at time 4. D releases L, cedes ownership to the head of the entry segment, E and then recirculates, adding itself to the arrival segment, now containing D+C+B+A, at time 5. E calls Release and, as the entry segment is empty, E detaches the arrival segment of D+C+B+A, shifting those threads into the arrival segment, and then enables D. E recirculates and joins the arrival segment, leaving the configuration as seen at time 6. D releases the lock and passes ownership to C and D then joins the arrival segment, as shown at time 7. C releases L and conveys ownership to B, and then prepends itself to the arrival segment, leaving the state as shown at time 8. B releases L, enables A, and then joins the arrival segment, leaving the state as shown at time 9. The states at times 1 and 9 are identical, so the admission schedule repeats with a period length of 8 steps.

### Long-term Admission Unfairness

While there is no long-term starvation, within the admission cycle ABCDEDCB we see that A and E are admitted just once while the others thread are admitted twice, which may manifest as long-term relative unfairness between the participating threads. While not a perfect palindrome, we say such a schedule is palindromic and note that the worst case admission fairness that might manifest is 2×.

A simple system model is assumed where all threads circulating over a lock access the same shared last-level cache (LLC). While threads are waiting, their residency in the LLC undergoes exponential decay because of the actions of the other threads executing in the critical section or their respective non-critical sections. Consider a true repeating palindrome admission schedule, ABCDE−EDCBA, as compared to the FIFO schedule of ABCDE−ABCDE. Applying a simplistic decay model, when a thread ceases waiting and takes ownership of the lock, it incurs a “cache reload transient” where it suffers a burst of cache misses as it reprovisions the LLC with its own previously displaced private data. The residual residency fraction can be approximated as Residual (T)=exp(−T*λ) where T is the sojourn or waiting time−the number of quanta since the thread last ran—and λ parameterizes the decay rate. As Residual is a convex function, Jensen's inequality may be employed. Taking thread B as a specific example, its waiting times under the FIFO schedule is always 4 time units and under the palindrome schedule the waiting time alternate 2-6 -2-6 etc. The average waiting time is the same under both schedules, but the average residual LLC residency when the thread resumes is the same or better under the palindrome schedule as Residual (2) +Residual (6)≥Residual (4)+Residual (4). In fact, each and every thread will have the same or better residual fraction under the palindrome schedule than under FIFO.

Intuitively, as the decay process is exponential in nature, the retained residency benefits accrued by the relatively short gap outweigh the decay penalty of the subsequent longer gap found in the palindrome schedule. The overall aggregate miss rate for the palindrome schedule, as computed over all the threads, will be less than thin the round-robin FIFO schedule, yielding better overall throughput. (Higher residency fractions implies reduced miss rates and better performance). Specifically, the palindrome schedule enjoys better overall aggregate LLC miss rates and throughput than a simple repeating round-robin FIFO schedule of ABCDE−ABCDE. And in fact the FIFO schedule is pessimal for aggregate miss rate if we require equal fairness as measured over two back-to-back cycles.

Consider an analogy in single-threaded code where an application needs to iterate over all elements of an array or linked list. A naive approach is to simply access the elements in ascending order until reaching the end, and then repeat, yielding a robin-robin order. Taking residual cache residency in account, however it is better to alternate ascending then descending orders—akin to a classic elevator seek or boustrophedonic order—which yields a palindrome access pattern.

### Cache-residency Unfairness

Considering a true repeating palindrome admission schedule, ABCDE−EDCBA, for instance, we have fair admission over the long term, but threads A and E will enjoy persistently lower LLC miss rates than B and D, which in turn will be lower than C, imposing a different form of unfairness related to residual cache residency. In particular, we identify another distinct source of long-term inter-thread unfairness that can arise from palindromic admissions, above and beyond the simple issue, above, of some threads being admitted less frequently. Under a palidrome schedule, threads can incur disparate cache hits rates, reflecting a form of long-term cache-based unfairness, even if the admission is long-term fair.

### Mitigation

If desired, unfairness from the effects above may be mitigated in a number of ways. A simple and expedient approach is to stochastically disrupt or perturb the repeating cycle, which reestablishes statistical long-term fairness. A viable technique is for incoming owners, having just acquired the lock, to run a thread-local Bernoulli trial, and based on the outcome, occasionally defer and immediately cede ownership to the next element in the entry segment, and propagate a reference to its wait element through the entry segment, where it will percolate to the tail, and eventually be re-granted ownership. This modification does not abrogate or otherwise violate our bypass guarantees or imperil anti-starvation as the reordering is strictly intra-segment.

More generally, selecting random elements, without replacement, from the entry segment for succession still retains the desirable population bounded anti-starvation property, statistically avoid long-term admission unfairness and cache residency fairness and continues to enjoy aggregate miss rates (and throughput) that on average are the same or better than classic FIFO.

### Retrograde Ticket Lock

In some embodiments, a retrograde ticket lock algorithm may mimic the admission order policy of Reciprocating Locks but is implemented as a version of a classic ticket lock algorithm. The classic ticket lock uses grant and ticket fields, where arriving threads atomically fetch-and-increment a ticket and then wait for the assigned ticket value to equal grant and the corresponding Release operator increments grant. For retrograde ticket locks we add new per-lock base and top fields.

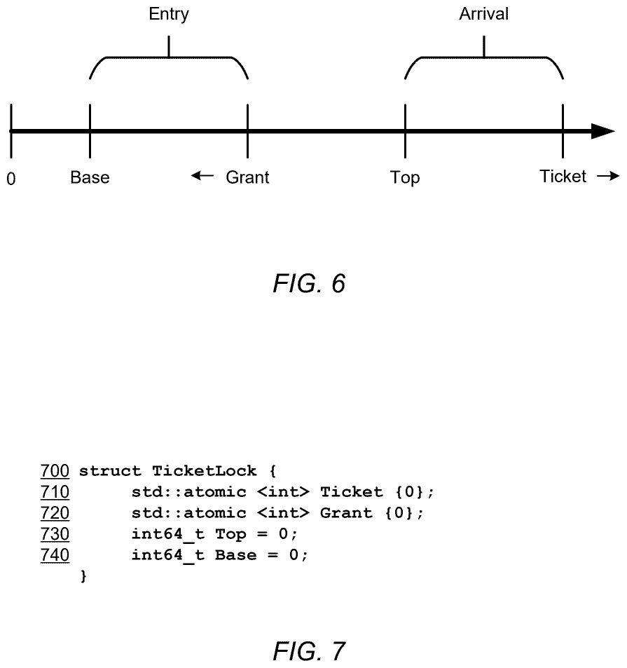

FIG. 6 is a block diagram illustrating a number line representing tickets of a ticket lock implementing reciprocating allocation, according to at least one embodiment. Assigned tickets in the range base—top represent the entry segment and those in range top—ticket represent the arrival segment. The entry and arrival regions are waiting for admission while other regions have already been granted ownership and are no longer waiting. While the entry segment remains populated with waiting threads, the Release operator advances the grant field in a descending fashion, yielding a retrograde order. When grant reaches base, the entry segment is exhausted, and we reprovision the entry segment by setting base to top and top to ticket. That is, the arrival segment becomes the new entry segment. By convention, top and base are accessed only by the current lock holder and only within the Release operation.

As magnitude-based comparisons may be used, arithmetic roll-over and aliasing of the ticket and grant becomes a concern. To address that issue we simply ensure that ticket-related fields are 64-bit integers. Assuming a processor could increment a value at most once per nanosecond, these fields would not overflow and wrap around in less than 200 years, so arithmetic overflow is not a practical concern. Assuming that std::atomic<int64_t>:fetch_add(1) is constant-time—which depends on both the library implementation of std::atomic and on the platform capabilities—our doorway phase is also also constant-time. Only one atomic read-modify-write fetch_add operation is required in Acquire and none in Release, and Release runs in constant-time.

The technique is not constrained to simple retrograde admission order within the entry segment. Consider that the entry segment consists of threads A−B−C−D which hold ticket values 1005−1004−1003−1002, respectively. A is the most recently arrived thread in the entry segment. Each thread waits for its corresponding ticket value to appear in the Grant field, which confers and conveys ownership. For retrograde admission, which mimics Reciprocating Locks, our admission order is A then B then C then D, using descending ticket values with the entry segment. A prograde admission order of D then C then B then A, with ascending ticket values, is tantamount to simple classic FIFO ticket locks. By using ticket values, a thread may be activated and enabled in constant-time at any arbitrary position (offset) in the entry segment, unlike Reciprocating Locks where the order is dictated, as threads know only the identity of their immediate neighbor. Using ticket-based succession allows a wider variety of admission orders, compared to Reciprocating Locks, as ticket-base successor allows random access to the elements of the entry segment and thus more latitude for succession order.

For example, a viable approach is the following. In the Release operator a biased Bernoulli trial may be performed and, based on the outcome, a successor selected from either the head of the remaining entry segment—the most-recently arrived thread—or the tail, which is the least recently arrived thread, but with the probability favoring the head. This yields a mostly LIFO admission order with the entry segment—mostly retrograde, but occasionally prograde. Crucially, the tunable Bernoulli probability may be used to strike a balance between fairness over a period, and aggregate throughput. Such randomization is sufficient to break or perturb long-term unfairness arising from repeating palindromic admission cycles.

As an optimization, to reduce the use of the random number generator, a per-lock CountDown variable may be implemented. The Release operator always decrements the counter. If the value is found greater than zero, a successor may be extracted from the head of the entry segment. Otherwise, a successor may be extracted from the tail, a small uniform random integer computed in the range 1 . . . M and then reset CountDown to that value. A simple low-latency low-quality pseudo-random generator number suffices, such as a single-word Marsaglia xor-shift variant.

A related technique is, in Release, when detaching a new arrival segment, to run a Bernoulli trial to pick a succession direction—prograde or retrograde but biased toward and favoring retrograde—and then use that direction for the entirety of the segment.

These forms use randomization to provide long-term statistical avoidance of both unfair admission and unfair cache residency, but still provide better aggregate cache residency (and throughput) than simple FIFO while also retaining the desirable thread-specific bounded bypass property.

FIG. 7 is a block diagram illustrating a data structure for a lock implemented using a retrograde ticket lock, according to at least one embodiment. Individual locks implemented using a retrograde ticket locks may include a data structure identified as the TicketLock 700, in various embodiments. This data structure may include an atomically updated integer Ticket value 710 that is initialized to a zero value and an atomically updated integer Grant value 720 that is initialized to a zero value. In addition, the data structure may include a long integer Top value 730 that is initialized to a zero value and a long integer Base value 740 that is initialized to a zero value.

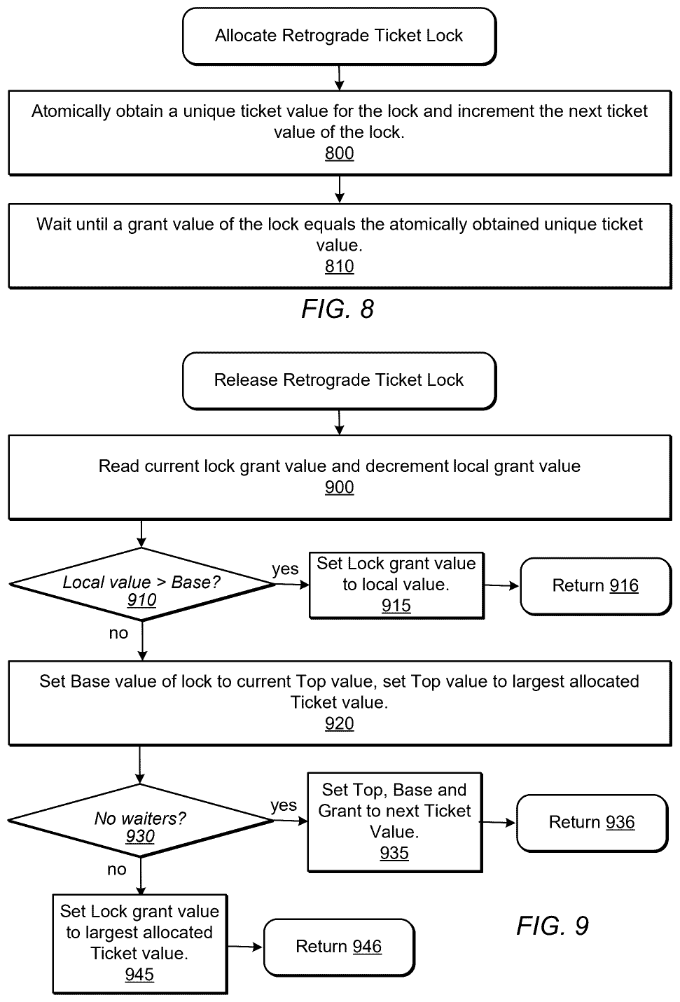

FIG. 8 is a flowchart illustrating one embodiment of a method for implementing allocation of a retrograde ticket lock. The process begins at 800 where a unique ticket value is obtained by atomically reading the Ticket, such as the Ticket 710 of FIG. 7, and incrementing the Ticket. Then, the process advances to 810 where a thread waits until a Grant value of the lock, such as the Grant 720 of FIG. 7, equals the obtained unique ticket value. The process is then complete.

FIG. 9 is a flowchart illustrating one embodiment of a method for implementing release of a retrograde ticket lock. The process begins at 900, where a current Grant value of the lock, such as the Grant 720 of FIG. 7, is loaded into a local grant value and the local value is decremented. If the decremented local grant value is greater than a Base value of the lock, such as the Base 740 of FIG. 7, as indicated by a positive exit from 910, the process proceeds to 915 where a Grant value of the lock, such as the Grant 720 of FIG. 7, is set to the decremented local value and the process is complete as shown in 916.

If the decremented local grant value is not greater than a Base value of the lock, such as the Base 740 of FIG. 7, as indicated by a negative exit from 910, the process proceeds to 920 where the Base value of the lock is set to a current Top value of the lock, such as the Top 730 of FIG. 7, then the Top value of the lock is set to a largest allocated Ticket value, such as one less than the Ticket value of the lock, such as the Ticket 710 of FIG. 7.

Then, in 930, it may be determined if there are waiters for the lock. This may be determined by comparing the current Base value of the lock to the current Top value. If they are equal, no waiters exist. If no waiters exist, as indicated by a positive exit from 930, the process may advance to 935 where the Top, Base and Grant values of the lock are set to the Ticket value of the lock to release the lock. The process is then complete, as shown in 936.

If waiters exist, as indicated by a negative exit from 930, the process may advance to 945 where the Grant value of the lock may be set to the largest allocated ticket value. The process is then complete, as shown in 946.

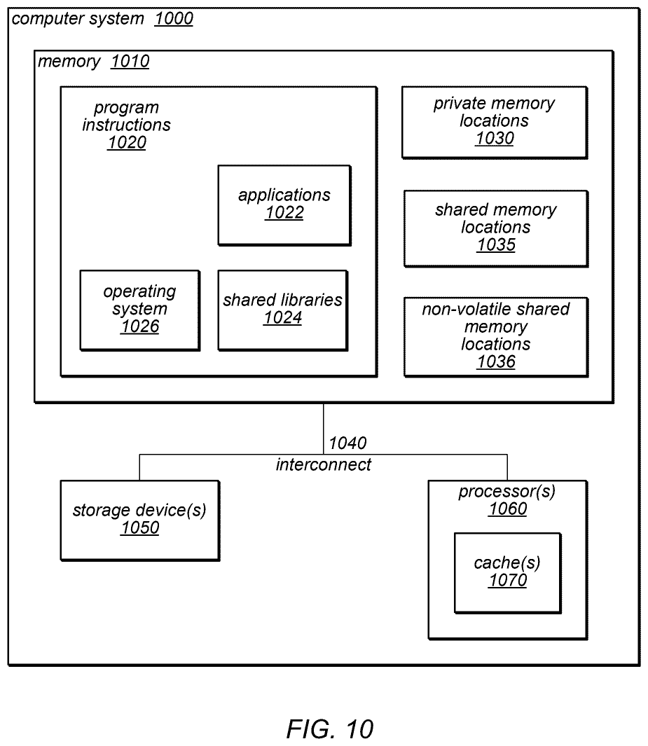

Some of the mechanisms described herein may be provided as a computer program product, or software, that may include a non-transitory, computer-readable storage medium having stored thereon instructions which may be used to program a computer system 1000 (or other electronic devices) to perform a process according to various embodiments. A computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.) In various embodiments, computer system 1000 may include one or more processors 1060; each may include multiple cores, any of which may be single-or multi-threaded. For example, multiple processor cores may be included in a single processor chip (e.g., a single processor 1060), and multiple processor chips may be included in computer system 1000. Each of the processors 1060 may include a cache or a hierarchy of caches 1070, in various embodiments, for which the various aspects of the enhanced Ticket Lock operation may be tuned such as in step 430 of FIG. 4 and step 211 of FIG. 2. For example, each processor chip 1060 may include multiple L1 caches (e.g., one per processor core) and one or more other caches (which may be shared by the processor cores on a single processor). The computer system 1000 may also include one or more storage devices 1050 (e.g. optical storage, magnetic storage, hard drive, tape drive, solid state memory, etc.) and one or more system memories 1010 (e.g., one or more of cache, SRAM, DRAM, RDRAM, EDO RAM, DDR 10 RAM, SDRAM, Rambus RAM, EEPROM, etc.). In some embodiments, one or more of the storage device(s) 1050 may be implemented as a module on a memory bus (e.g., on interconnect 1040) that is similar in form and/or function to a single in-line memory module (SIMM) or to a dual in-line memory module (DIMM). Various embodiments may include fewer or additional components not illustrated in FIG. 10 (e.g., video cards, audio cards, additional network interfaces, peripheral devices, a network interface such as an ATM interface, an Ethernet interface, a Frame Relay interface, etc.) The one or more processors 1060, the storage device(s) 1050, and the system memory 1010 may be coupled to the system interconnect 1040. One or more of the system memories 1010 may contain application data 1028 and program instructions 1020. Application data 1028 may contain various data structures to implement enhanced ticket locks while Program instructions 1020 may be executable to implement one or more applications 1022, shared libraries 1024, and/or operating systems 1026.

Program instructions 1020 may be encoded in platform native binary, any interpreted language such as Java™ byte-code, or in any other language such as C/C++, the Java™ programming language, etc., or in any combination thereof. In various embodiments, applications 1022, operating system 1026, and/or shared libraries 1024 may each be implemented in any of various programming languages or methods. For example, in one embodiment, operating system 1026 may be based on the Java programming language, while in other embodiments it may be written using the C or C++ programming languages. Similarly, applications 1022 may be written using the Java programming language, C, C++, or another programming language, according to various embodiments. Moreover, in some embodiments, applications 1022, operating system 1026, and/ shared libraries 1024 may not be implemented using the same programming language. For example, applications 1022 may be C++ based, while shared libraries 1024 may be developed using C.

Although the embodiments above have been described in considerable detail, numerous variations and modifications will become apparent to those skilled in the art once the above disclosure is fully appreciated. For example, although many of the embodiments are described in terms of particular types of operations that support synchronization within multi-threaded applications that access particular shared resources, it should be noted that the techniques and mechanisms disclosed herein for accessing and/or operating on shared resources may be applicable in other contexts in which applications access and/or operate on different types of shared resources than those described in the examples herein. It is intended that the following claims be interpreted to embrace all such variations and modifications.

In conclusion, multiple embodiments of an enhanced ticket lock are disclosed. With these enhancements, locking operations retain the advantages of classic ticket lock implementations, including low latency locking under low-contention conditions, while improving performance under high-contention conditions through improved transfer of ownership in the unlock path. Experimental results demonstrate that the enhanced ticket lock operation matches the performance of classic ticket locks, under conditions most favorable to classic ticket locks and in applications where ticket locks are traditionally preferred, while also meeting and often exceeding the performance of alternative locking approaches such as the MCS lock under high-contention conditions where the classic ticket lock traditionally suffers. For example, in a benchmark consisting of multiple threads executing a common critical section and contending for a single lock, the classic ticket lock, MCS lock and enhanced ticket lock exhibit similar performance for very low thread count. For increasing thread counts, the MCS lock exhibits higher latency and lower throughput but good scalability to very high thread counts while the classic ticket lock exhibits initially higher throughput but poor scalability and rapidly decline throughput at very high thread counts. In contrast, the enhanced ticket lock offers throughput significantly improved over the MCS lock and essentially matching the classic ticket lock while providing scalability equal to that of the MCS lock. For these reasons, the enhanced ticket lock provides significant performance advantages over traditional lock implementations.

What is claimed:

1. A computer-implemented method comprising:
requesting, by a first thread of a plurality of threads executing on one or more processors, to allocate a lock, the requesting comprising atomically inserting a request to allocate the lock for exclusive access to a resource in an arrival queue of the lock, wherein the inserting returns an indicator of a held state of the lock;
performing, by a second thread of the plurality of threads currently holding the lock, an operation to release the lock, comprising:
atomically transferring, responsive to determining that a wait queue of the lock is empty, the arrival queue of the lock to the wait queue of the lock; and
transferring hold of the lock to a third thread of the plurality of threads associated with a most recently arrived request to allocate the lock on the wait queue.

2. The computer-implemented method of claim 1, wherein atomically inserting the request to allocate the lock comprises atomically exchanging an address of a waiting element for the first thread with a value of an arrival word for the lock, wherein the exchanging returns the indicator of the held state of the lock, and wherein the requesting further comprises:
storing the indicator, responsive to the indicator identifying another waiting element on the arrival queue, in the waiting element to identify a successor waiting to hold the lock; and
atomically setting the arrival word for the lock to indicate a locked state responsive to the indicator indicating an unlocked state.

3. The computer-implemented method of claim 1, wherein performing the operation to release the lock further comprises:
selecting the third thread, prior to transferring hold of the lock to the third thread, from among a plurality of waiting threads of the plurality of threads according to a selection order for the wait queue.

4. The computer-implemented method of claim 3, wherein the selection order is the same as an arrival order for the arrival queue.

5. The computer-implemented method of claim 3, wherein the selection order is different from an arrival order for the arrival queue.

6. The computer-implemented method of claim 1, wherein the requesting further comprises transferring control of the lock to a fourth thread identified by another indicator of the held state of the lock responsive to a failure to atomically set the arrival word for the lock to indicate a locked state.

7. The computer-implemented method of claim 1, wherein the requesting further comprises storing another value of the arrival word, responsive to a failure to atomically set the arrival word for the lock to indicate a locked state, in the waiting element to identify a successor waiting to hold the lock.

8. One or more non-transitory computer-accessible storage media storing program instructions that when executed on or across one or more processors cause the one or more processors to implement a plurality of threads to perform:
requesting, by a first thread of a plurality of threads, to allocate a lock, the requesting comprising atomically inserting a request to allocate the lock for exclusive access to a resource in an arrival queue of the lock, wherein the inserting returns an indicator of a held state of the lock;
performing, by a second thread of the plurality of threads currently holding the lock, an operation to release the lock, comprising:
atomically transferring, responsive to determining that a wait queue of the lock is empty, the arrival queue of the lock to the wait queue of the lock; and
transferring hold of the lock to a third thread of the plurality of threads associated with a most recently arrived request to allocate the lock on the wait queue.

9. The one or more non-transitory computer-accessible storage media of claim 8, wherein the requesting comprises atomically exchanging an address of a waiting element for the first thread with a value of an arrival word for the lock, wherein the exchanging returns the indicator of the held state of the lock, and wherein the requesting further comprises:
storing the indicator, responsive to the indicator identifying another waiting element on the arrival queue, in the waiting element to identify a successor waiting to hold the lock; and
atomically setting the arrival word for the lock to indicate a locked state responsive to the indicator indicating an unlocked state.

10. The one or more non-transitory computer-accessible storage media of claim 8, wherein performing the operation to release the lock further comprises:
selecting the third thread, prior to transferring hold of the lock to the third thread, from among a plurality of waiting threads of the plurality of threads according to a selection order for the wait queue.

11. The one or more non-transitory computer-accessible storage media of claim 10, wherein the selection order is the same as an arrival order for the arrival queue.

12. The one or more non-transitory computer-accessible storage media of claim 10, wherein the selection order is different from an arrival order for the arrival queue.

13. The one or more non-transitory computer-accessible storage media of claim 8, wherein the requesting further comprises transferring control of the lock to a fourth thread identified by another indicator of the held state responsive to a failure to atomically set the arrival word for the lock to indicate a locked state.

14. The one or more non-transitory computer-accessible storage media of claim 8, wherein the requesting further comprises storing another value of the arrival word, responsive to a failure to atomically set the arrival word for the lock to indicate a locked state, in the waiting element to identify a successor waiting to hold the lock.

15. A system, comprising:
one or more processors and a memory, the memory comprising program instructions executable by the one or more processors to implement a plurality of threads, the plurality of threads configured to:
request, by a first thread of a plurality of threads executing on one or more processors, to allocate a lock, the requesting comprising atomically inserting a request to allocate the lock for exclusive access to a resource in an arrival queue of the lock, wherein the inserting returns an indicator of a held state of the lock;
perform, by a second thread of the plurality of threads currently holding the lock, an operation to release the lock, wherein to perform the operation the second thread is configured to:
atomically transfer, responsive to determining that a wait queue of the lock is empty, the arrival queue of the lock to the wait queue of the lock; and
transfer hold of the lock to a third thread of the plurality of threads associated with a most recently arrived request to allocate the lock on the wait queue.

16. The system of claim 15, wherein to atomically insert the request to allocate the lock, the first thread is configured to atomically exchange an address of a waiting element for the first thread with a value of an arrival word for the lock, wherein the exchanging returns the indicator of the held state of the lock, and wherein the requesting further comprises:
store the indicator, responsive to the indicator identifying another waiting element on the arrival queue, in the waiting element to identify a successor waiting to hold the lock; and
atomically set the arrival word for the lock to indicate a locked state responsive to the indicator indicating an unlocked state.

17. The system of claim 15, wherein to perform the operation to release the lock further, the second thread is configured to:
select the third thread, prior to transferring hold of the lock to the third thread, from among a plurality of waiting threads of the plurality of threads according to a selection order for the wait queue.

18. The system of claim 17, wherein the selection order is the same as an arrival order for the arrival queue.

19. The system of claim 17, wherein the selection order is different from an arrival order for the arrival queue.

20. The system of claim 15, wherein to request to allocate the lock, the first thread is configured to transfer control of the lock to a fourth thread identified by another indicator of the held state responsive to a failure to atomically set the arrival word for the lock to indicate a locked state.
